(19) United States
(12) Patent Application Publication
(10) Pub. No.: US 2004/0128532 A1
(43) Pub. Date: Jul. 1, 2004

(54) Image forming apparatus and use control method

(76) Inventors: Tsutomu Ohishi, Fukuoka (JP); Katsuhiko Nakagawa, Fukuoka (JP); Takumi Hirai, Fukuoka (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/660,698

(22) Filed: Sep. 12, 2003

(30) Foreign Application Priority Data
Sep. 13, 2002 (JP) 2002-269285
Sep. 10, 2003 (JP) 2003-318476
Sep. 10, 2003 (JP) 2003-318477

(51) Int. Cl. H04L 9/00

(52) U.S. Cl. 713/200

(57) ABSTRACT

An image forming apparatus is provided, in which a plurality of applications can be installed in the image forming apparatus, the image forming apparatus includes: a use control part for receiving one or more authentication results from one or more authentication parts, and controlling use restriction for one or more applications according to the received one or more authentication results.

### BACKGROUND OF THE INVENTION

1. Field of the Invention

The present invention relates to an image forming apparatus that provides user services relating to image forming processes such as copying, printing, scanning, facsimile and the like. More particularly, the present invention relates to an image forming apparatus that can manages a plurality of authentication/billing apparatuses and a plurality of authentication/billing applications.

2. Description of the Related Art

Recently, an image forming apparatus (to be referred to as a compound machine hereinafter) that includes functions of a printer, a copier, a facsimile, a scanner and the like in a cabinet is generally known. The compound machine includes a display part, a printing part and an image pickup part and the like in a cabinet. In the compound machine, three pieces of software corresponding to the printer, copier and facsimile respectively are provided, so that the compound machine functions as the printer, the copier, the scanner and the facsimile respectively by switching the software.

Since the conventional compound machine is provided with each software for the printer, the copier, the scanner and the facsimile individually, much time is required for developing the software. Therefore, the applicant has developed an image forming apparatus (compound machine) including hardware resources, a plurality of applications, and a platform including various control services provided between the applications and the hardware resources. The hardware resources include a display part, a printing part and an image pickup part, and are used for image forming processes. The applications perform processes intrinsic for user services of printer, copier and facsimile and the like. The platform includes various control services performing management of hardware resources necessary for at least two applications commonly, performing execution control of the applications, and image forming processes, when a user service is executed.

According to such a compound machine, for strengthening security, when the user uses the compound machine, user authentication is performed by using a user ID and a password so as to restrict use of the compound machine by an invalid user or to restrict use of the compound machine on the basis of billing information of the user. According to the compound machine including the authentication capability and the billing capability, generally, user IDs and passwords are managed by an authentication database in a storage of the compound machine, and, user IDs and billing information are managed by a billing database in the storage of the compound machine. Recently, compound machines are used in an environment in which a plurality of compound machines are connected via a network such as a LAN (Local Area Network) and/or the Internet, and the compound machines are used from a computer such as a PC or a work station. Therefore, it is necessary to provide the authentication database and the billing database for each compound machine connected to the network, and it is necessary to manage the user IDs and the passwords in each compound machine.

However, for managing the authentication information and the billing information such as the user IDs and the passwords in the authentication database and the billing database in the compound machine, it is necessary to manage the authentication database and the billing database separately for each compound machine. Thus, there is a problem in that management of authentication information and billing information becomes complicated.

That is, since permitted users my be different for each compound machine, it is necessary to determine which compound machine is usable by a user when information specific to the user is to be updated. Thus, when many compound machines are connected on a network, work load for managing the authentication information and the billing information increases.

In addition, when authentication information and billing information for one user is changed, it is necessary to update the authentication database and the billing information for all of the compound machines on the network. Thus, if system managers are different for each compound machine, the work load for maintenance of the authentication information and the billing information becomes large.

In addition, even when update of the authentication database is restricted to a system manager of the compound machine, it is easy to tamper the authentication database or the billing database, by disguising as the system manager. That is, improving security is a problem.

There are a plurality of methods for authentication and billing, and there is a possibility that a plurality of authentication/billing systems are used in a compound machine. However, there has been no technology for managing the plurality of authentication/billing systems in the compound machine, and for using the plurality of authentication/billing systems for restricting use of one or more applications.

### SUMMARY OF THE INVENTION

An object of the present invention is to provide an image forming apparatus that can use a plurality of authentication/billing systems for a plurality of applications, in which the plurality of authentication/billing systems may include an authentication/billing system using an external server that manages user information such as authentication information and billing information.

The above-object is achieved by an image forming apparatus in which a plurality of applications can be installed, the image forming apparatus including:

a use control part for receiving one or more authentication results from one or more authentication parts, and controlling use restriction for one or more applications according to the received one or more authentication results.

According to the present invention, one or more authentication part can be applied to one or more applications

The use control part refers to information indicating one or more authentication parts that correspond to an application, causes the one or more authentication parts to perform authentication process when the application is used, and sends an authentication result to the application.

Accordingly, authentication by one or more authentication parts can be performed for one application.

In addition, the use control part may refer to information indicating one or more applications that correspond to an authentication part, and sends an authentication result of the authentication part to an application in the one or more applications when the application is used. Therefore, for use of one or more applications, a predetermined authentication part can be used.

In the image forming apparatus, the use control part may include a part for controlling use restriction for a function of the application. Therefore, use restriction can be controlled for each function of an application.

In the image forming apparatus, the use control part may send an authentication result indicating success of authentication to the one or more applications only when authentication by all of the one or more authentication parts succeeds.

Also, the use restriction part may send an authentication result indicating success of authentication to the one or more applications when authentication by at least one authentication part in the one or more authentication parts succeeds.

Thus, relationship between the one or more authentication parts can be determined. Therefore, proper authentication can be performed according to properties of applications.

In the image forming apparatus, each of the one or more authentication part may be an application or an apparatus connected to the image forming apparatus. Therefore, as an authentication part, not only a new authentication application but also a conventional externally connected apparatuses can be used.

In the image forming apparatus, the authentication part may performs authentication by using user authentication information input by a user and user authentication information registered beforehand. The authentication part also may perform authentication by using billing information input by a user and available billing information registered beforehand.

The image forming apparatus may further includes hardware resources used for image forming processes, and control services that perform processes of the system side including control of the hardware resources, wherein the image forming apparatus is configured so as to be able to install a plurality of applications separately from the control services, and the image forming apparatus includes the use control part as a control service.

The above-object is also achieved by an image forming apparatus in which a plurality of applications can be installed, the image forming apparatus including:

a display part for displaying a screen, on an operation panel of the image forming apparatus, for selecting one or more applications for an authentication part, in which user authentication by the authentication part is applied to use of the one or more applications; and

a use control part for receiving an authentication result from the authentication part, and controlling use restriction for the one or more applications according to the authentication result.

According to the present invention, one or more applications can be selected for an authentication part, so that authentication of the authentication part can be applied to the selected one or more applications.

In the image forming apparatus, information input from the screen may be stored in the image forming apparatus as information indicating the one or more applications corresponding to the authentication part. Thus, the use control part can perform control according to the stored information.

In the image forming apparatus, the display part displays a screen for selecting one or more functions of an application to which user authentication by the authentication part is applied.

The above-object can be also achieved by an image forming apparatus in which a plurality of applications can be installed, the image forming apparatus including:

a display part for displaying a screen, on an operation panel of the image forming apparatus, for selecting one or more authentication parts for an application, in which user authentication by the one or more authentication parts can be applied to use of the application; and

a use control part for receiving one or more authentication results from the one or more authentication parts, and controlling use restriction for the application according to the one or more authentication results.

According to the present invention, one or more authentication parts can be selected for an application, so that authentication of the one or more authentication parts can be applied to the application.

The information input from the screen may be stored in the image forming apparatus as information indicating the one or more authentication parts corresponding to the application.

In the image forming apparatus, the display part may display a screen for setting relationship among the one or more authentication parts. Also, the display part may display a screen for setting information indicating that user authentication for use of the application succeeds only if authentication by all of the one or more authentication parts succeeds. In addition, the display part may display a screen for setting information indicating that user authentication for use of the application succeeds if authentication by at least one of the one or more authentication parts succeeds. Therefore, proper authentication can be performed even when one or more authentication parts are used for an application.

### BRIEF DESCRIPTION OF THE DRAWINGS

Other objects, features and advantages of the present invention will become more apparent from the following detailed description when read in conjunction with the accompanying drawings, in which:

FIG. 1 shows a main configuration of the compound machine and a network configuration including the compound machine according to the first embodiment of the present invention;

FIG. 2 is a block diagram of the compound machine according to the first embodiment of the present invention;

FIG. 3 shows an example of a hardware configuration of the compound machine;

FIG. 4 shows data flows in the user authentication process in the compound machine;

FIG. 5 is a flowchart of the procedure of the user authentication process;

FIG. 6 shows a user name/password input screen;

FIG. 7 shows the procedure of the entry search request process;

FIG. 8 shows a main configuration of the compound machine and a network configuration including the compound machine according to the second embodiment;

FIG. 9 is a block diagram showing a functional configuration of the compound machine of the second embodiment;

FIG. 10 shows data flows in the billing process and the use restriction process by the compound machine of the second embodiment;

FIG. 11 is a flowchart of the procedure of the use restriction process according to the second embodiment;

FIG. 12 is a figure for explaining the capability of the CCS of the third embodiment;

FIG. 13 shows a software configuration of the CCS according to the third embodiment;

FIG. 14 is an example of code in the device interface part;

FIG. 15 shows a screen in which a list of usable authentication/billing systems is displayed;

FIG. 16 shows a screen for selecting functions of applications to which authentication/billing is applied;

FIG. 17 shows a screen for selecting functions of applications to which authentication/billing is applied;

FIG. 18 shows an example of stored setting information set by using the screen shown in FIGS. 16 and 17;

FIG. 19 shows an example of a screen for performing setting;

FIG. 20 shows a screen for selecting applications to which authentication/billing is performed;

FIG. 21 is an example of stored setting information by performing setting by using the screen shown in FIG. 20;

FIG. 22 shows an example of a screen for performing setting;

FIG. 23 shows a screen for selecting authentication/billing systems that is applied to an application.

### DETAILED DESCRIPTION OF THE PREFERRED EMBODIMENTS

In the following, the image forming apparatus and use control method will be described with reference to figures.

(First Embodiment)

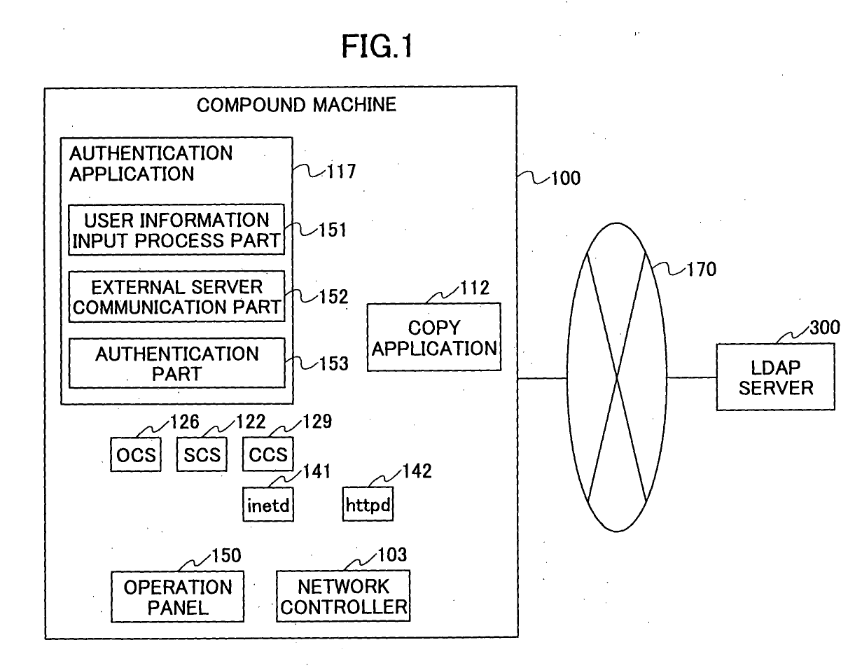

FIG. 1 shows a main configuration of the image forming apparatus (to be referred as “compound machine” hereinafter) and a network configuration including the compound machine according to the first embodiment. The compound machine 100 of the first embodiment displays an input screen for inputting a user name and a password on the operation panel. Then, the compound machine 100 request an external server on the Internet to search for an password corresponding to the input user name, and performs user authentication by comparing the input password and the password obtained from the outside. Then, the compound machine 100 can restrict use of the compound machine for an invalid user.

As shown in FIG. 1, the compound machine 100 of this embodiment is connected to the Internet 170 which connects a LDAP (Lightweigh Directiry Access Protocol) sever 300. TCP/IP is used for the communication protocol between the compound machine 100 and the LDAP server 300.

As the main configuration for realizing the user authentication method in the compound machine 100, as shown in FIG. 1, the compound machine 100 mainly includes applications such as an authentication application 117 and a copy application, after mentioned control services, inetd 141 and httpd 142 that operate as daemons, a network controller 103, and an operation panel 150.

The LDAP server 300 is a server for providing a directory service according to a X.500 based protocol that is simplified for the Internet. In the LDAP server 300, a password, a mail address, and personal information are stored for each user name.

The authentication application 117 performs user authentication process based on the user name and the password by using the LDAP server. The authentication application 117 includes a user information input process part 151, an external server communication part 152 and an authentication part 153.

The user information input processing part 151 displays a user name/password input screen on an operation display part of the operation panel 150, and receives the user name and the password, in which user name/password input screen is used for inputting a user name (user identifying information) and a password 8user authentication information) that represents validity of the user.

The external server communication part 152 sends the user ID that is input from the operation display part to the LDAP sever 300. The LDAP server searches for a password corresponding to the user name of the compound machine 100. The external server communication part 152 receives the password as the search result.

The authentication part 153 determines whether the password received from the LDAP sever 300 and the password input from the operation panel are the same, and sends the determination result to the CCS 129 by using interprocess communication.

The CCS (Certified Control Service) 129 is a control service for performing user restriction or billing process. According to the compound machine 100 of this embodiment, the CCS 129 receives the determination result of the user authentication from the authentication part 153 of the authentication application 117, and, sends information, to the copy application 112, indicating whether use of the copy application 112 is restricted for the user. The control services such as the OCS 126 and the SCS 122 will be described later.

The inetd 141 is a daemon that always monitors a data receive/send request. When the inetd 141 detects a connection request for a protocol, the inetd 141 launches a server program for handling the protocol. The inetd 141 is similar to the inetd of UNIX. In the compound machine 100 of the first embodiment, the inetd 141 always monitors a port for receiving/sending data of http or https protocol. When the inetd 141 detects a connection request on the port, the inetd launches httpd 142.

The httpd 142 always monitors the port 80 that receives a message sent by the http or https protocol. The httpd 142 receives a request message and sends a response message on the port 80. The structure of the request message and the response message is the same as a normal message of the http protocol. Each message includes a message body of html format.

The network controller 103 is used for data communication by the http protocol and the https protocol.

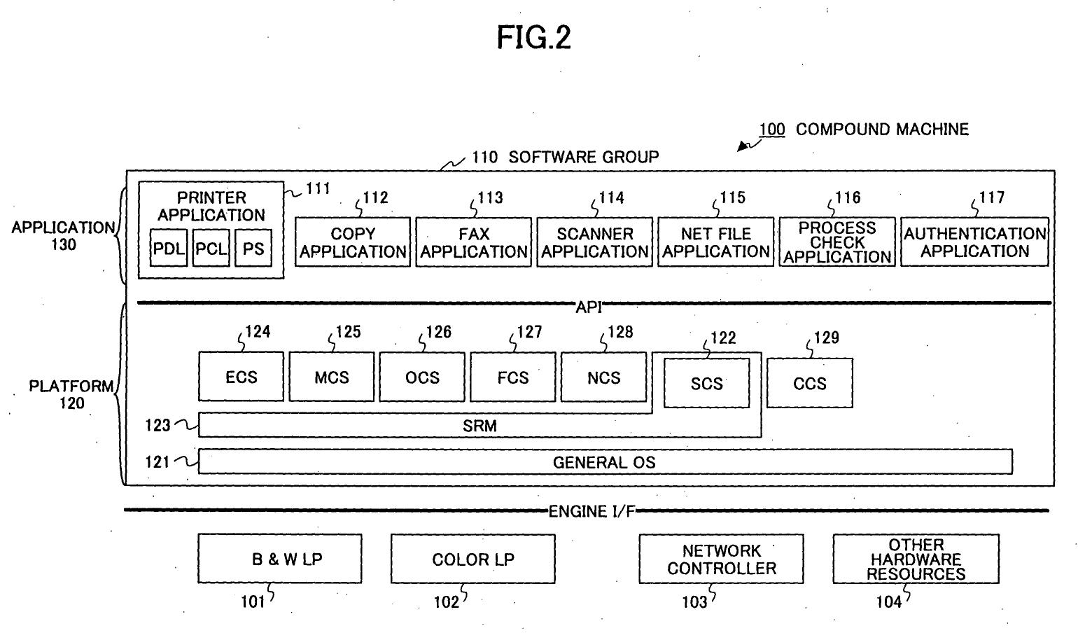

Next, the whole functional configuration of the compound machine 100 will be described. FIG. 2 is a block diagram of the compound machine according to the first embodiment of the present invention.

As shown in FIG. 2, the compound machine 100 includes hardware resources and a software group 110. The hardware resources include a black and white line printer (B&W LP) 101, a color laser printer (Color LP) 102, and hardware resources 103 such as a scanner, a facsimile, a hard disk, memory and a network interface. The software group 110 includes a platform 120, applications 130.

The platform 120 includes control services for interpreting a process request from an application and issuing an acquiring request for hardware resources, a system resource manager (SRM) 123 for managing one or more hardware resources and arbitrating the acquiring requests from the control services, and a general-purpose OS 121.

The control services include a plurality of service modules, which are a system control service (SCS) 122, an engine control service (ECS) 124, a memory control service (MCS) 125, an operation panel control service (OCS) 126, a fax control service (FCS) 127, a network control service (NCS) 128 and a certification control service (CCS) 129. In addition, the platform 120 has application program interfaces (API) that can receive process requests from the applications 130 by using predetermined functions.

The general purpose OS 121 is a general purpose operating system such as UNIX, and can execute each piece of software of the platform 120 and the applications 130 concurrently as a process.

The process of the SRM 123 is for performing control of the system and for performing management of resources with the SCS 122. The process of the SRM 123 performs arbitration and execution control for requests from the upper layer that uses hardware resources including engines such as the scanner part and the printer part, a memory, a HDD file, a host I/Os (Centronics I/F, network I/F IEEE1394 I/F, RS232C I/F and the like).

More specifically, the SRM 123 determines whether the requested hardware resource is available (whether it is not used by another request), and, when the requested hardware resource is available, notifies the upper layer that the requested hardware resource is available. In addition, the SRM 123 performs scheduling for using hardware resources for the requests from the upper layer, and directly performs processes corresponding to the requests (for example, paper transfer and image forming by a printer engine, allocating memory area, file generation and the like).

The process of the SCS 122 performs application management, control of the operation part, display of system screen, LED display, resource management, and interrupt application control.

The process of the ECS 124 controls engines of hardware resources including the white and black laser printer (B&W LP) 101, the color laser printer (Color LP) 102, the scanner, and the facsimile and the like. The process of the MCS 125 obtains and releases an area of the image memory, uses the hard disk apparatus (HDD), and compresses and expands image data.

The process of the FCS 127 provides APIs for sending and receiving of facsimile from each application layer by using PSTN/ISDN network, registering/referring of various kinds of facsimile data managed by BKM (backup SRAM), facsimile reading, facsimile receiving and printing, and mixed sending and receiving.

The NCS 128 is a process for providing services commonly used for applications that need network I/O. The NCS 128 distributes data received from the network by a protocol to a corresponding application, and acts as mediation between the application and the network when sending data to the network. More specifically, the process of the NCS 128 includes server daemon such as ftpd, httpd, lpd, snmpd, telnetd, smtpd, and client function of the protocols.

The process of the OCS 126 controls an operation panel that is a means for transferring information between the operator (user) and control parts of the machine. In the compound machine 100 of the embodiment, the OCS 126 includes an OCS process part and an OCS function library part. The OCS process part obtains an key event, which indicates that the key is pushed, from the operation panel, and sends a key event function corresponding to the key event to the SCS 122. The OCS function library registers drawing functions and other functions for controlling the operation panel, in which the drawing functions are used for outputting various images on the operation panel on the basis of a request from an application or from the control service. The OCS function library is dynamically linked to the application and each module of the control services. All of the OCS 126 can be configured as a process, or can be configured as an OCS library.

The application 130 includes a printer application 111 that is an application for a printer having page description language (PDL) and PCL and post script (PS), a copy application 112, a fax application 113, a scanner application 114 that is an application for a scanner, a network file application 115, a process check application 116 and the authentication application 117.

Interprocess communication is performed between a process of the application 130 and a process of the control service, in which a function is called, a returned value is sent, and a message is sent and received. By using the interprocess communication, user services for image forming processes such as copying, printing, scanning, and sending facsimile are realized.

As mentioned above, the compound machine 100 of the first embodiment includes a plurality of applications 130 and a plurality of control services, and each of those operates as a process. In each process, one or more threads are generated and the threads are executed in parallel. The control services provide common services to the applications 130. User services on image formation such as copying, printing, scanning and sending facsimile are provided while the processes are executed in parallel, the threads are executed in parallel, and interprocess communication is performed. A third party vendor can develop applications for the compound machine 100, and can executes the application in an application layer on the control service layer in the compound machine 100. The authentication may be one of the applications.

In the compound machine 100 of the first embodiment, although processes of applications 130 and processes of control services operate, the application and the control service can be a single process. In addition, an application in the applications 130 can be added or deleted one by one.

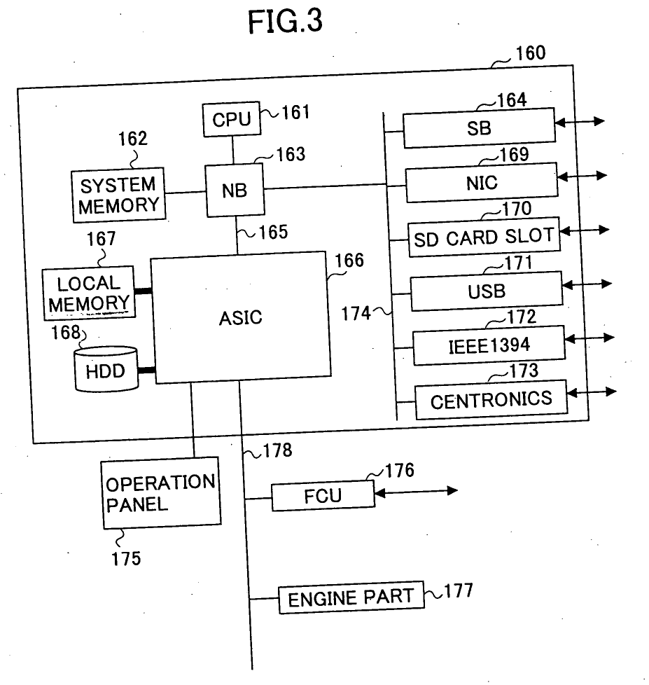

FIG. 3 shows an example of a hardware configuration of the compound machine 100.

The compound machine 100 includes a controller 160, an operation panel 175, a fax control unit (FCU) 176, and an engine part 177 that is hardware resource such as a printer that is specific for image forming processing. The controller 160 includes CPU 161, a system memory 162, a north bridge (NB) 163, a south bridge (SB) 164, ASIC 166, a local memory 167, HDD 168, a network interface card (NIC) 169, a SD card slot 170, a USB device 171, an IEEE1394 device 172, and a Centronics 173. The memories 162, 167 may includes RAMs and/or ROMs, for example. The FCU 176 and the engine part 177 are connected to the ASIC 166 in the controller via a PCI bus 178. The CPU 161 executes programs of the application and control services and the like installed in the compound machine 100 by reading data from a RAM.

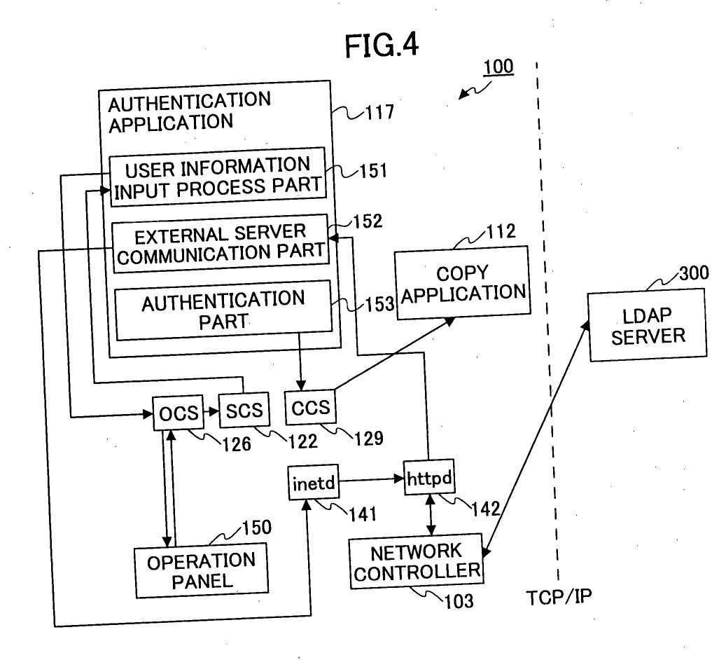

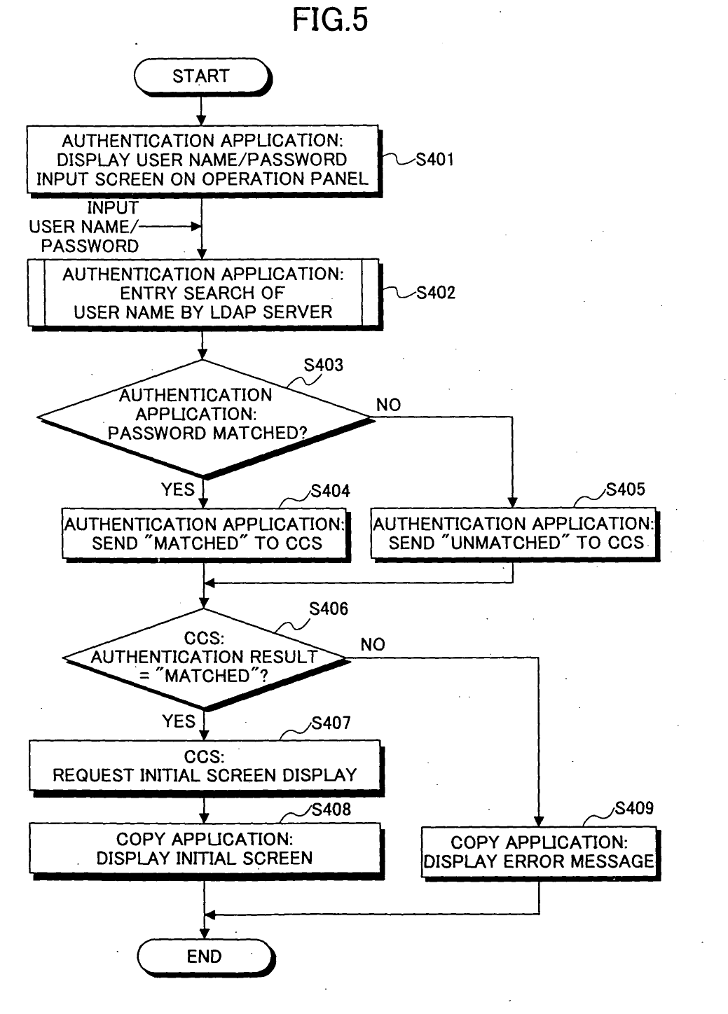

In the following, the user authentication method by the compound machine 100 of the first embodiment will be described. FIG. 4 shows data flows in the user authentication process in the compound machine 100. FIG. 5 is a flowchart of the procedure of the user authentication process.

According to the compound machine 100, after the power is turned on, the copy application 112 is launched first. At that time, user authentication is performed. If the authentication succeeds, an initial screen of the copy application 112 is displayed on the operation display part 150a of the operation panel 150, so that the user can perform copy operations.

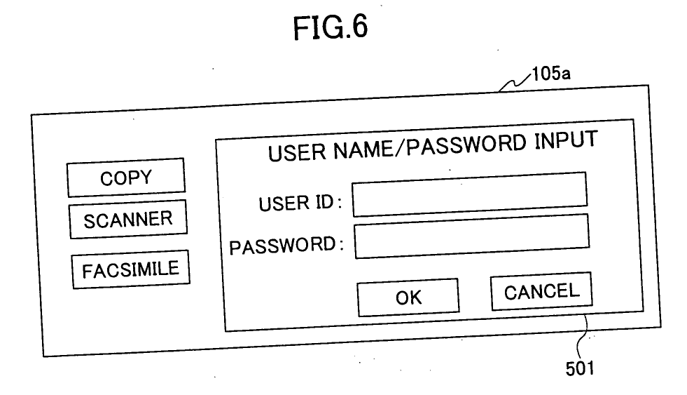

First, the user information input process part 151 in the authentication application 117 displays the user name/password input screen 501 shown in FIG. 6 on the operation display part 150a of the operation panel 150 in step S401. The screen is displayed by performing drawing function call to the OCS function library. When a key is input from the operation display part 150a, the key event of the input key is obtained by the OCS 126, and is sent to the user information input process part 151 of the authentication application 117 via the SCS 122.

When the user name and the password are input from the user name/password input screen 501, the external server communication part 152 of the authentication application 117 sends the input user name and an entry search request to the LDAP server 300, so that the LDAP server 300 searches for an entry of user name in step S402. When the external server communication part 152 sends the user name and the entry search request, the inetd 141 launches the httpd 142 and the httpd 142 sends the user name and the entry search request to the LDAP server via the network controller 103. The search result is sent to the external server communication part 152 via the network controller 103 and the httpd 142.

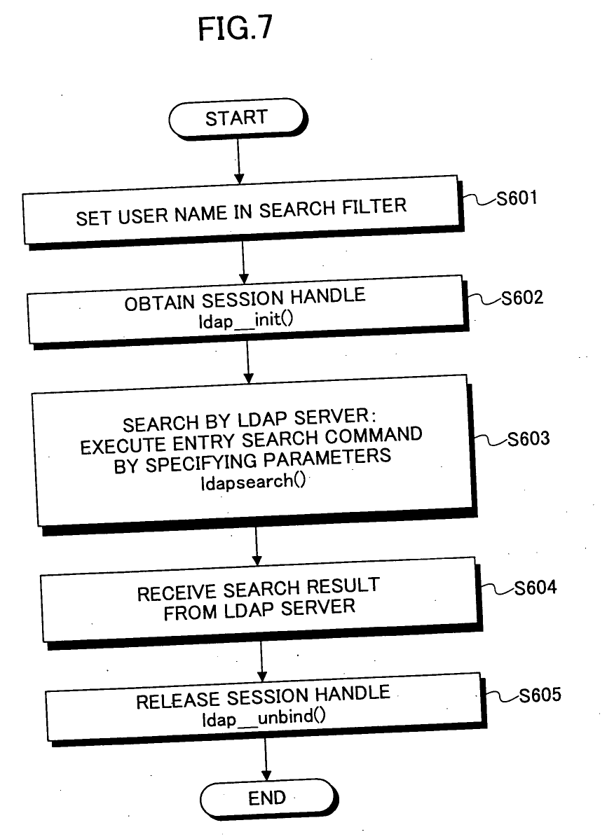

In the following, the process of step S402 will be described in more detail. FIG. 7 shows the procedure of the entry search request process.

The external server communication part 152 sets the user ID to the search filter in step S601. More specifically, for example, “user ID XXXXXX” is set in the search filer.

Next, in step S602, ldap_init ( ) function is issued to obtain a session handle to be used operations hereinafter. After obtaining the session handle, the external server communication part 152 executes a search function for the LDAP server 300. More specifically, ldapsearch ( ) function is called by specifying parameters in step S603. The parameters are IP address of the destination LDAP server, destination port, connection authorization password, search position, the search filter set in step S601, and search attribute (password is specified).

Then, the password corresponding to the user ID is searched for, so that the searched password is received from the LDAP server in step S604. Then, finally, to release the session handle, ldap_unbind ( ) function is called. Then, a series of search request process ends.

Next, as shown in FIG. 5, the authentication part 153 of the authentication application 117 determines whether the password received from the LDAP server 300 and the password input by the user are the same in step S403. When they are the same, the authentication part 153 sends the authentication result “matched” to the CCS 129 in step S404. When they are not the same, the authentication result “unmatched” to the CCS 129 in step S405. The CCS 129 that received the authentication result determines whether the authentication result is “matched” in step S406. If the result is “matched”, it is determined that the user is valid, and the copy application 112 can be used by the user. In this case, the CCS 129 sends display request of an initial screen to the copy application 112 in step S407. Then, the copy application 112 displays the initial screen on the operation display part 150a on the operation panel 150 in step S408. The CCS 129 may send the authentication result to the copy application. After that, for example, the copy application request the CCS 129 to stop displaying an authentication screen.

When the result is “unmatched”, the CCS 129 displays an error message indicating that use of the copy application is restricted on the operation display part 150a in step S409. Alternatively, the CCS 129 may send the authentication result to the application, and the application may displays an error message.

In this embodiment, the determination whether the input password and the received password are the same can be performed in the LDAP server. In addition, each of the password and the user ID can be input from an PC connected to the network instead of inputting from the operation panel.

As mentioned above, according to the compound machine 100 of the first embodiment, the user information input process part 151 of the authentication application 117 receives the user ID and the password from the user, and the external communication part 152 sends the user ID to the LDAP server 300 connected to the Internet 170. Then, the external server communication part 152 receives a password that is searched for by the LDAP server 300. Then, the authentication part 153 determines whether the password input by the user and the password sent from the LDAP server are the same, and the determination result is sent to the CCS 129. Thus, the compound machine does not need to have any authentication database in the inside, and the load for maintaining the database is decreased. In addition, since it is not necessary to include the authentication database in each compound machine 100, the password is prevented from tampered, and the security of the compound machine can be improved.

(Second Embodiment)

According to the compound machine 100 of the first embodiment, a screen for inputting the user name and the password is displayed on the operation panel, and the user ID is sent to the external server on the Internet to request a password corresponding to the user ID. On the other hand, according to the compound machine 700 of the second embodiment, the compound machine 700 receives a user name and billing data from a PC 200 on the Internet, and the compound machine 700 request billing data from an external server.

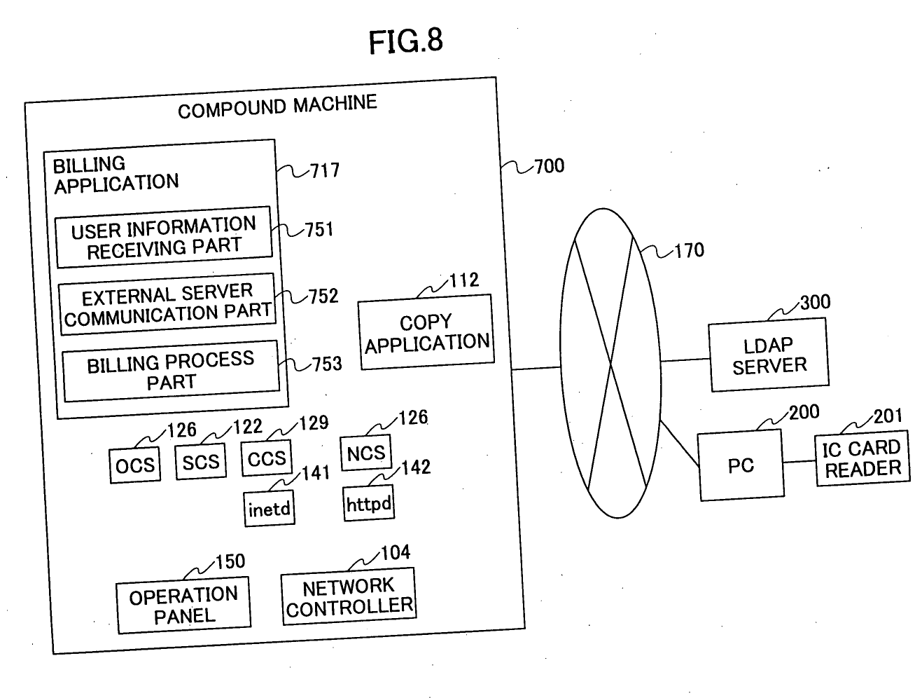

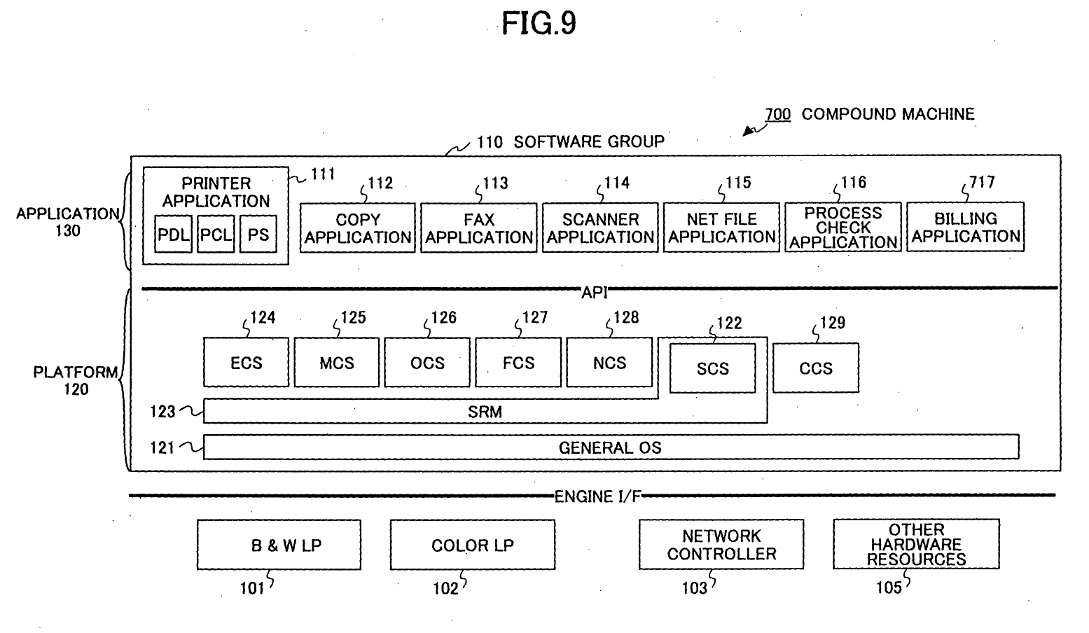

FIG. 8 shows a main configuration of the compound machine 700 and a network configuration including the compound machine according to the second embodiment. FIG. 9 is a block diagram showing a functional configuration of the compound machine 700.

As shown in FIG. 8, the compound machine 700 of this embodiment is connected to the Internet 170 which connects a LDAP (Lightweigh Directiry Access Protocol) sever 300 and a PC 200 as a client terminal. TCP/IP is used for the communication protocol for the compound machine 700, the LDAP server 300 and the PC 200.

As a main configuration for realizing use restriction of the compound machine 700 in the second embodiment, as shown in FIG. 8, the compound machine 700 mainly includes applications such as a billing application 717 and a copy application, control services such as OCS 126, SCS 122 and CCS 129, inetd 141 and httpd 142, and a network controller, and an operation panel 150.

The LDAP server 300 of this embodiment stores password, mail address and billing data for each user name. The billing data are, for example, budget (available amount of money), available number of A4 papers, available number of B5 papers.

The PC 200 of this embodiment connects an IC card reader 201 for reading an IC card. The IC card reader 201 reads a user name and billing data from an IC card, and sends the user name and the billing data to the compound machine 700. The billing data recorded in the IC card are, for example, used amount of money, used number of A4 papers, used number of B5 papers and the like.

The billing application 717 in the compound machine 700 performs billing process by using the LDAP server 300. The billing application 717 includes a user information receiving part 751, an external server communication part 752 and billing process part 753.

The user information receiving part 751 receives the user name and the password from the PC 200.

The external server communication part 752 sends a user ID input from the operation panel 150 to the LDAP server 300. The LDAP server 300 searches for billing data corresponding to the user name. Then, the external server communication part 752 receives the billing data from the LDAP server 300.

The billing process part 753 compares the billing data received from the LDAP server 300 and the billing data receives from the PC 200. Then, the billing process part 753 determines whether the billing data receives from the PC 200 indicates a value that is within a range of a value indicated by the billing data received from the LDAP server 300. Then, the billing process part 753 sends the determination result (within the range, or, out of the range) to the CCS 129 by using interprocess communication.

The CCS (Certificate Control Service) 129 is a control service for controlling user restriction or billing process. According to the compound machine 700 of this embodiment, the CCS 129 receives the determination result from the billing process part 753. Then, the CCS 129 sends information indicating whether to perform use restriction to the copy application 112. Other configuration of the compound machine 700 is the same as that of the first embodiment.

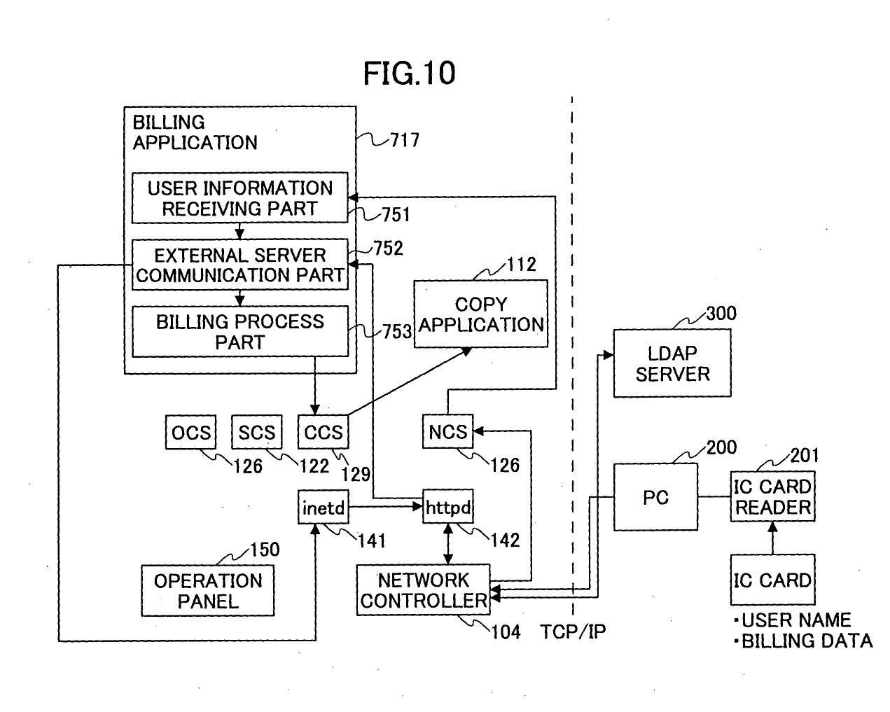

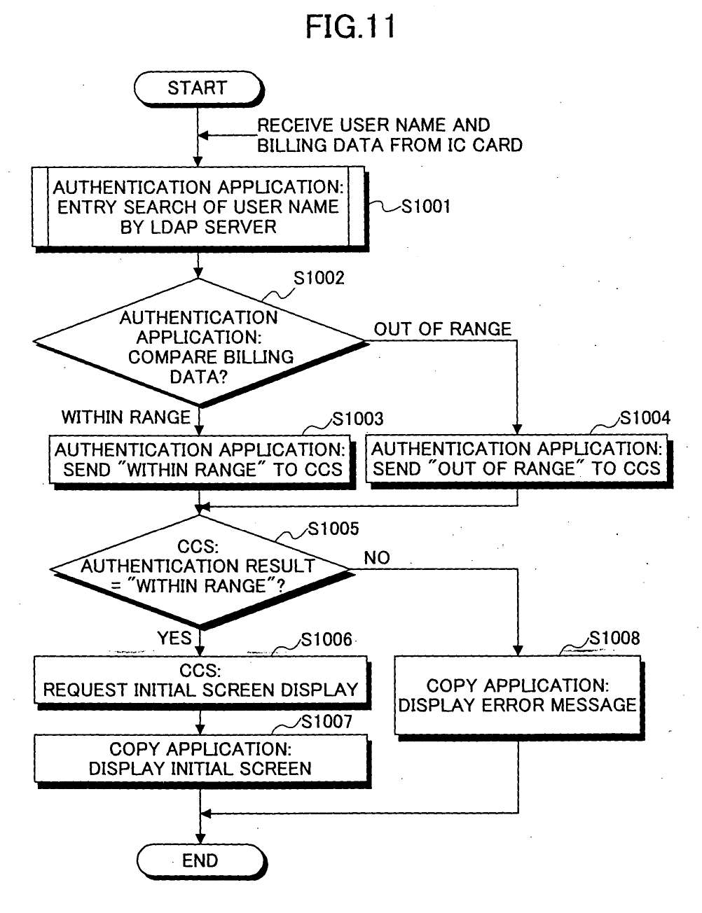

Next, use restriction process by the compound machine 700 of the second embodiment will be described. FIG. 10 shows data flows in the billing process and the use restriction process by the compound machine 700. FIG. 11 is a flowchart of the procedure of the use restriction process.

When the compound machine 700 receives a user name and billing data from the PC 200, the billing application 717 is executed in an event-driven manner. Then, the billing application 717 performs the comparing process. If the determination result indicates that the use of the copy application 112 is not restricted, the copy application 112 outputs an initial screen on the operation display part of the operation panel 150, so that the user can perform copy operations.

The user information receiving part 751 in the billing application 717 receives a user name and billing data from the PC 200. More specifically, the user name and the billing data sent by the PC 200 is received by the network controller 1004 of the compound machine 700. Then, the user information receiving part 751 receives the user name and the billing data via the NCS 126. After that, the external server communication part 752 sends the user name and an entry search request to the LDAP server 300, so that the LDAP server 300 searches for an entry of the user name in step S1001. The entry search request process by the external server communication part 752 is the same as that of the first embodiment. In this embodiment, ldapsearch function is called in which “billing data” is set as the search attribute.

Next, the billing process part 753 of the billing application 717 compares the billing data received from the LDAP server 300 and the billing data received from the PC 200, and determines whether the billing data received from the PC 200 is within a range of the billing data received from the LDAP server 300 in step S1002. When the billing data is within the range, the billing process part 753 sends a determination result “within range” to the CCS 129 in step S1003. On the other hand, when the billing data is not within the range, a determination result “out of range” is sent to the CCS 129 in step S1004.

The CCS 129 that received the result determines whether the result is “within range” in step S1005. For example, the CCS 129 determines whether the used amount of money is smaller than the available amount of money, or whether used number of papers is less than available number of papers according to the result received from the billing application. If the result is “within range”, the CCS 112 does not restrict use of the copy application, so that the user can determine that the compound machine 700 still can be used. In this case, the CCS 129 requests the copy application 112 to display an initial screen in step S1006. Then, the copy application 112 that receives the request displays the initial screen on the operation display part 150a of the operation panel 150 in step S1007.

On the other hand, when the CCS 129 determines that the result is “out of range” in step S1005, the CCS 129 displays an error message on the operation panel in step S1008, in which the error message indicates that the use of the copy application 112 is restricted. Alternatively, the CCS 129 sends the result “out of range” to the copy application 112, and the copy application 112 displays the error message.

As mentioned above, according to the compound machine 700 of the second embodiment, the user information receiving part 751 receives the user ID and the billing data from the PC 200. Then, the external server communication part 752 sends the user ID to the LDAP server 300. After that, the LDAP server 300 searches for billing data corresponding to the user ID, and the external server communication part 752 receives the searched billing data. Then, the billing process part 753 compares the billing data received by the external server communication part 152 and the billing data received by the user information receiving part 751. Then, the billing process part 753 sends the comparison result to the CCS 129. Therefore, it is not necessary that the compound machine includes a billing database, so that work load for maintenance of the billing database decreases. In addition, since it is not necessary to have the billing database in the compound machine, unauthorized tampering with information such as billing data can be prevented, so that the security of the compound machine 700 improves.

Billing for copying can be also performed in the following way. In the following example, the billing data received from the LDAP server is an available number of copies to be made by the user, and the billing data read from the IC card is a used number of copies that has already been made by the user.

As mentioned above, if the used number of copies is less than the available number of copies, the user can copy a document. In such a case, the billing application holds the available number of copies and the used number of copies. Each time when the compound machine copies a document, the copy application issues a print job to the ECS via the SCS. Then, the ECS sends a paper eject completion notification to the billing application. When the billing application receives the paper eject completion notification, the billing application increments the used number, and compares the incremented used number and the available number of copies. In addition, the used number is updated in the IC card. If the incremented used number is less than the available number of copies, the compound machine can continue to copy the document. On the other hand, the used number reaches the available number, the billing application notifies the CCS that the used number reaches the available number, and the CCS requests the copy application to stop copying.

Since the billing application determines whether to permit or not to permit use of the copy application on the basis of a condition, the billing application can be called as an authentication application.

(Third Embodiment)

Next, the third embodiment will be described. In the first and second embodiment, the user restriction is performed by using the authentication application or the billing application. According to the compound machine of the third embodiment, a plurality of applications and/or apparatuses for authentication/billing can be used.

The whole configuration of the compound machine of the third embodiment is almost the same as that of FIG. 2. The compound machine of the third embodiment can include a plurality of authentication/billing applications. In addition, the compound machine of the third embodiment can connect conventional external authentication/billing apparatuses such as a key counter, a coin lack and a key card and the like.

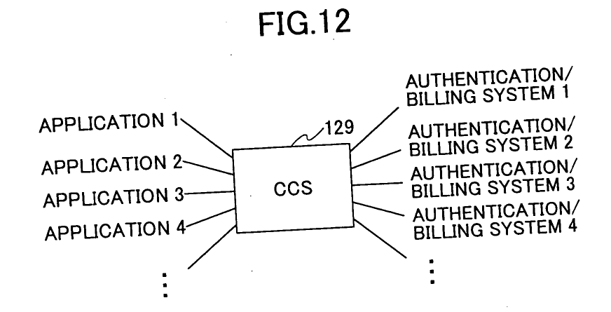

FIG. 12 is a figure for explaining the capability of the CCS 129 of the third embodiment. In the following description, each of the external authentication/billing apparatus such as the key card, and the authentication/billing application such as those described in the first and second embodiment can be referred to as “authentication/billing system”.

As shown in FIG. 12, the CCS 129 connects a plurality of authentication/billing systems and a plurality of applications that are covered by the authentication/billing systems. In addition, the CCS 129 manages information indicating which authentication/billing system is used for which application. The plurality of authentication/billing systems may include the external billing apparatus such as the coin lack and the authentication/billing application such as that described in the first and second embodiment. For example, the authentication/billing system 1 may be a new authentication/billing application installed in the compound machine, and the authentication/billing system 2 may be a conventional key counter or a key card.

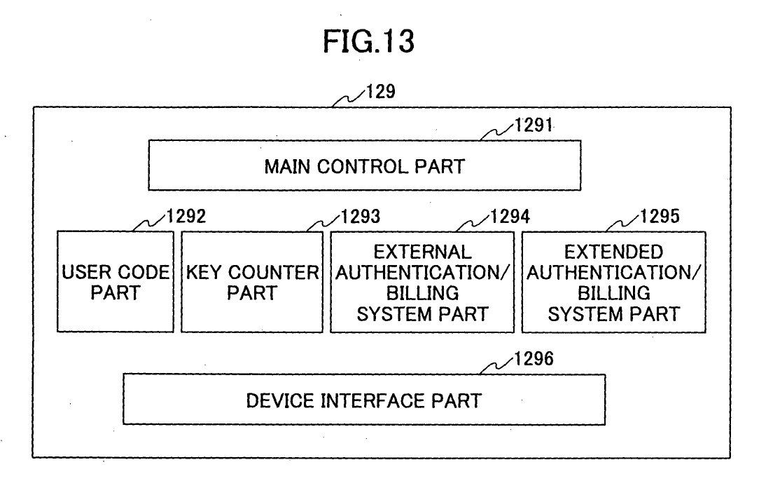

FIG. 13 shows a software configuration of the CCS 129. The CCS 129 of the third embodiment includes a main control part 1291, a user code part 1292, a key counter part 1293, an external authentication/billing system part 1294 and an extended authentication/billing system part 1295 and a device interface part 1296.

The main control part 1291 controls the whole process of the CCS 129. The user code part 1292 is for user authentication by using user ID. The authentication itself is performed by an application or a control service such as SCS. The user code part 1292 manages setting information indicating that which applications use the user code authentication. In addition, the user code part 1292 obtains an authentication result, sends the authentication result to the main control part 1291. The key counter part 1293 is used when authentication/billing is performed by the key counter. The external authentication/billing system part 1294 is used when authentication/billing is performed by using an external authentication/billing apparatus such as the key card and the coin lack and the like. The extended authentication/billing system part 1295 is used when authentication/billing is performed by using an authentication/billing system such as that described in the first and second embodiment. Like the user code part 1292, each of the parts 1293-1295 manages setting information indicating target applications, obtains authentication result, and sends the result to the main control part 1291. The CCS 129 can be also configured such that the main control part 1291 refers to information indicating which authentication/billing system covers which application.

The CCS 129 shown in FIG. 13 is one example. More authentication/billing system parts can be provided according to connected authentication/billing apparatuses and authentication billing applications to be used.

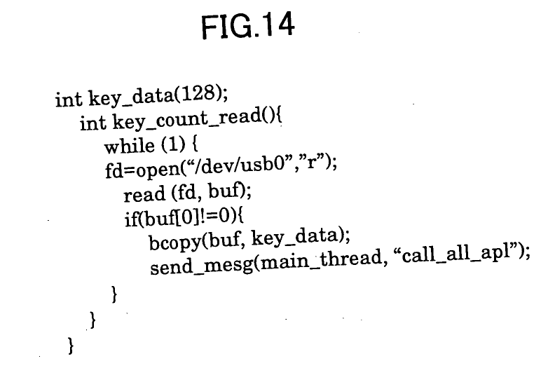

The device interface part 1296 is used for connecting the external authentication/billing apparatus such as the key card, the coin lack and the like to the CCS 129. For example, by using code shown in FIG. 14, the device interface part 1296 detects insert of a card into the external apparatus, reads authentication result information from the apparatus, and sends an instruction to the main control part 1291. For example, in a case when the authentication result is “OK”, the instruction may be an instruction for instructing the main control part 1291 to permit all applications to operate normally.

Next, setting for associating authentication/billing systems with applications to be covered by the authentication/billing systems will be described. By performing the setting, it is determined which application is covered by which authentication/billing system.

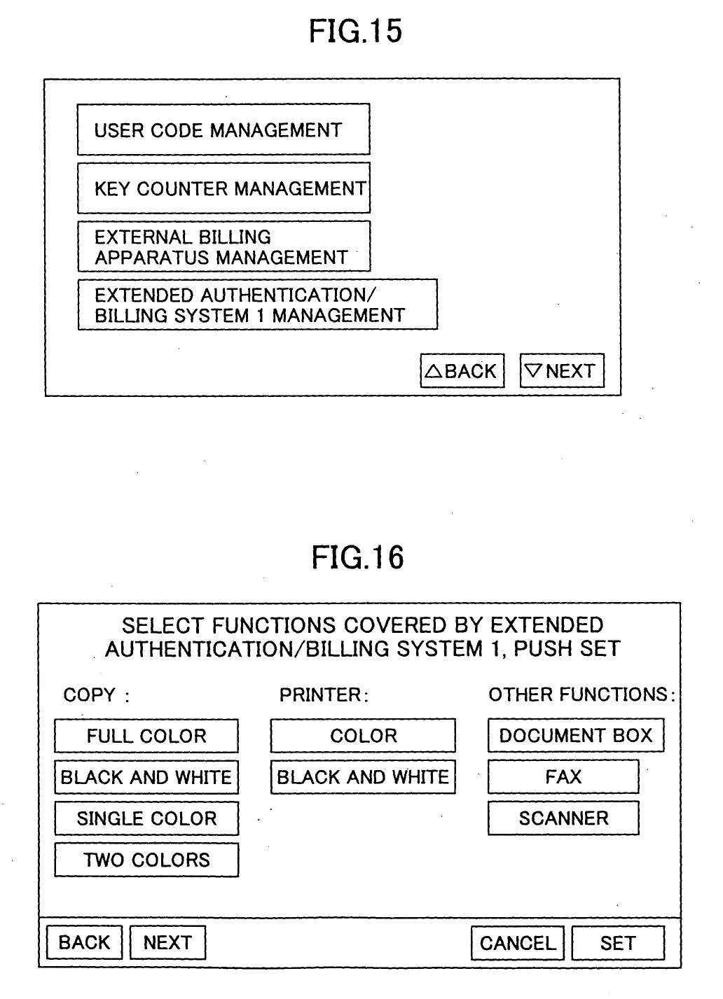

FIGS. 15-18 shows examples of setting screens shown on the operation panel of the compound machine. The screens may be displayed by the CCS 129. The screens can be also displayed by the SCS 122 by exchanging information for display between the SCS 122 and the CCS 129. In the following example, the CCS 129 displays the screen.

First, as shown in FIG. 15, a list of usable authentication/billing systems is displayed. In the figure, the button “external billing apparatus management” is used for making settings for apparatuses such as the coin lack and key card and the like. The button “extended authentication/billing system 1 management” is used for making settings for new authentication/billing applications. By pushing “Next” button, another systems such as “extended authentication/billing system 2 management” can be displayed.

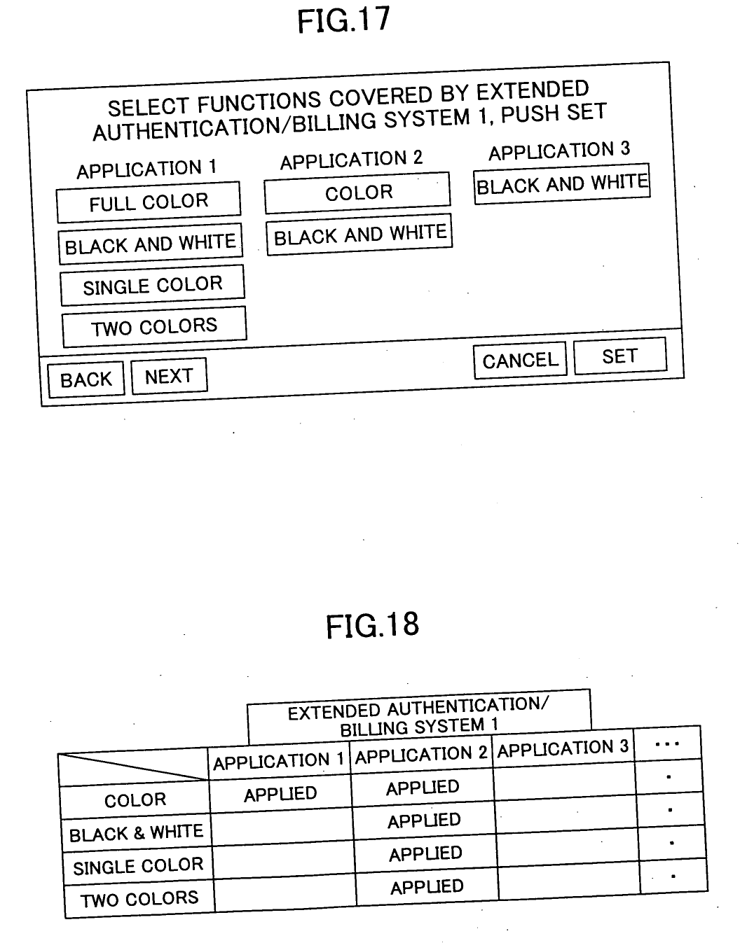

In the screen shown in FIG. 15, when “extended authentication/billing system 1 management” is selected, a screen shown in FIG. 16 is displayed. In addition, by pushing “Next page”, future new applications can be shown as shown in FIG. 17. In the screen shown in FIGS. 16 and 17, one or more applications for which the selected authentication/billing system 1 performs authentication/billing are selected. In the screen of FIGS. 16 and 17, one or more functions in an application can be selected. For example, when “full color” is selected in the copy application, authentication/billing operation is performed by the extended authentication/billing system 1 only when the user uses the full color function of the copy application.

The setting information set from the above-mentioned screens are stored in a storage as information shown in FIG. 18. According to the setting shown in FIG. 18, use restriction process is performed by the extended authentication/billing system 1 when color capability of application 1 is used. As to application 2, use restriction process is performed when the application 2 is used.

When the application 1 is used, for example, information indicating that a color capability of the application 1 will be used is sent to the CCS 129 from the application 1. Then, the CCS 129 refers to information shown in FIG. 18 so as to determine whether the color capability of the application 1 is a target for an authentication/billing system. Then, if the CCS 129 finds an authentication/billing system that covers the color capability of the application 1, the CCS 129 instruct the found authentication/billing system to operate for the application 1.

For example, in a state in which setting to use the authentication/billing system 1 for the function 1 of the application 1 is already done, if the user further makes setting to use the authentication/billing system 2 for the function 1 of the application 1, the CCS 129 may display a screen for inputting relationship between the authentication/billing system 1 and the authentication/billing system 2 at the time when the setting for the authentication/billing system 2 is made, and the CCS 129 may record the relationship. For example, setting can be made in which the function 1 of the application 1 will be permitted if either one of authentication by the system 1 or the system 2 succeeds. Also, setting can be made in which use of the function 1 of the application 1 will be permitted only if authentication by both of the system 1 and the system 2 succeeds.

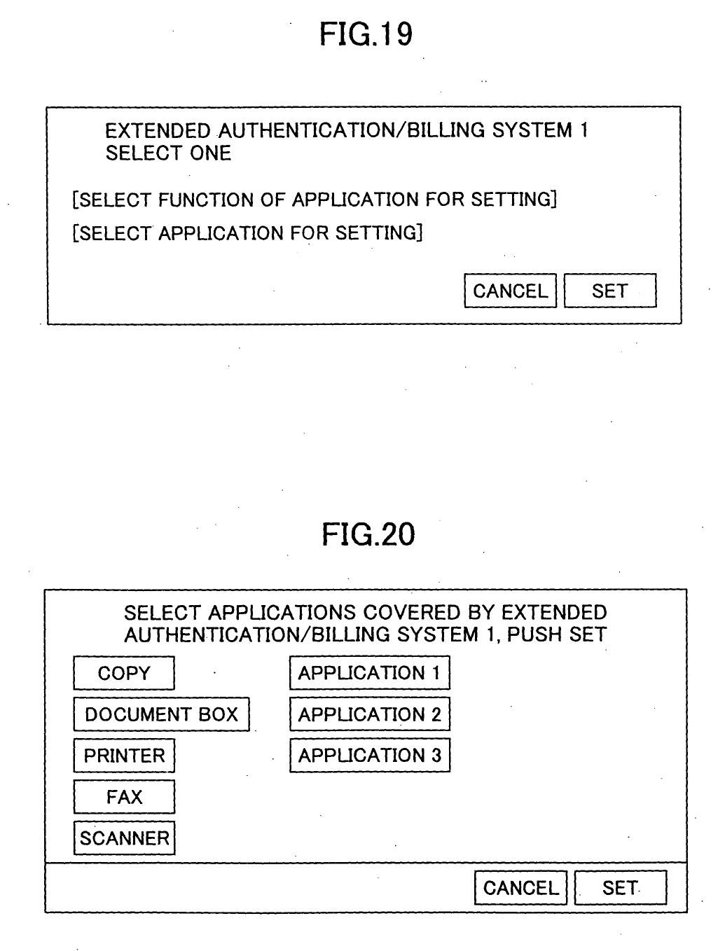

In addition to the screens shown in FIGS. 16-18, screens shown in FIGS. 19-20 can be displayed. In this case, for example, if the extended authentication/billing system 1 is selected in the screen of FIG. 15, a screen shown in FIG. 19 will be displayed. In the screen, “setting by selecting function of application” or “setting by selecting application” is selected.

If “setting by selecting function of application” is selected, screens same as those shown in FIGS. 16 and 17 are displayed, and the settings can be made same similarly.

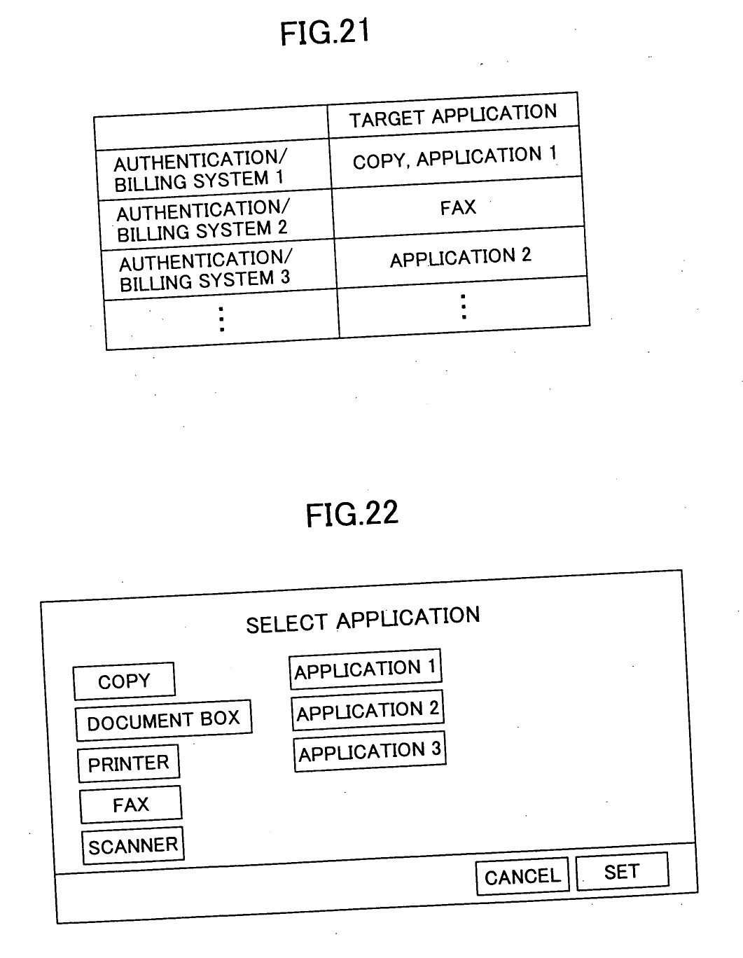

If “setting by selecting application” is selected, a screen shown in FIG. 20 is displayed. In this screen, when an application is selected, the corresponding authentication/billing application operates for any capability of the application. For the setting shown in FIG. 20, information shown in FIG. 21 is recorded, for example. The CCS 129 refers to the table, so that the CCS 129 operates an authentication/billing application for the corresponding application that is going to be used by the user. For example, when one of the copy application or the application 1 is going to be used, the authentication/billing system 1 operates, so that authentication is performed and the authentication result is sent to the application via the CCS.

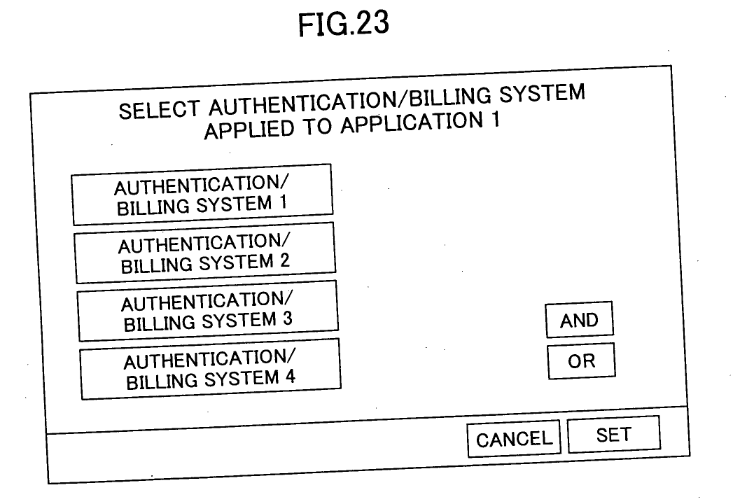

The above-mentioned examples are for selecting one or more applications for an authentication/billing system. In addition, setting can be made for selecting one or more authentication/billing systems for one application. Examples of screens for this case are shown in FIGS. 22-23.

First, a screen shown in FIG. 22 is displayed. In the screen, for example, if an application 1 is selected, a screen shown in FIG. 23 is displayed. The authentication/billing system selected in this screen is applied to the application 1. Further, a plurality of authentication/billing systems can be selected. As for selecting a plurality of authentication/billing systems, AND setting can be made in which, only if authentication of every authentication/billing system succeeds, the result “OK” is sent to the application. In addition, OR setting can be made in which, if authentication of one of the authentication/billing systems succeeds, the result “OK” is sent to the application. For making such settings, for example, after the user selects an authentication/billing system, the user pushes AND or OR button. After that, the user further selects an authentication/billing system. As a result, AND or OR relationship can be set between the authentication/billing system selected firstly and the authentication/billing system selected secondly in this case, for example, information such as “authentication system 1 AND authentication system 2” is recorded with the corresponding application. Then, the CCS 129 refers to this information so as to operate both of the authentication/billing systems for the corresponding application. Then, only when both of authentication results are OK, the CCS 129 sends a result “OK” to the corresponding application. Then, the application can operate.

Depending on the specification of an application, there may be a case in which an authentication/billing system can not be used by the application. Therefore, before displaying the screen of FIG. 23, the application may notify the CCS 129 of applicable authentication/billing systems. On the basis of the notification, the CCS 129 may display a screen indicating authentication/billing systems applicable to the application.

The operation of the CCS 129 when an authentication/billing system operates is similar to that in the first and second embodiment. In the third embodiment, the CCS 129 refers to the above-mentioned setting information. In addition, the CCS 129 can receive authentication results from a plurality of authentication/billing systems. When all of the results indicate “OK”, the CCS 129 can send the result “OK” to one or more applications according to the setting information. In addition, according to the setting information, the CCS 129 can send the result “OK” to one or more applications when one of the results indicates “OK”.

As described in the first embodiment, the CCS 129 may request an authentication/billing application to display an authentication screen for restricting operation of an target application that is launched when the power of the compound machine is turned on. In addition, the CCS 129 may detect an application change request, and may request an authentication/billing application to display an authentication screen for restricting the use of the changed application. When AND relationship is set among a plurality of authentication/billing applications, for example, authentication of the authentication/billing applications may be performed in turn.

The present invention is not limited to the specifically disclosed embodiments, and variations and modifications may be made without departing from the scope of the present invention.

What is claimed is:

1. An image forming apparatus in which a plurality of applications can be installed, the image forming apparatus comprising:
a use control part for receiving one or more authentication results from one or more authentication parts, and controlling use restriction for one or more applications according to the received one or more authentication results.

2. The image forming apparatus as claimed in claim 1, wherein the use control part refers to information indicating one or more authentication parts that correspond to an application, causes the one or more authentication parts to perform authentication process when the application is used, and sends an authentication result to the application.

3. The image forming apparatus as claimed in claim 1, wherein the use control part refers to information indicating one or more applications that correspond to an authentication part, and sends an authentication result of the authentication part to an application in the one or more applications when the application is used.

4. The image forming apparatus as claimed in claim 1, wherein the use control part includes a part for controlling use restriction for a function of the application.

5. The image forming apparatus as claimed in claim 1, wherein the use control part sends an authentication result indicating success of authentication to the one or more applications only when authentication by all of the one or more authentication parts succeeds.

6. The image forming apparatus as claimed in claim 1, wherein the use restriction part sends an authentication result indicating success of authentication to the one or more applications when authentication by at least one authentication part in the one or more authentication parts succeeds.

7. The image forming apparatus as claimed in claim 1, wherein each of the one or more authentication part is an application or an apparatus connected to the image forming apparatus.

8. The image forming apparatus as claimed in claim 1, wherein the authentication part performs authentication by using user authentication information input by a user and user authentication information registered beforehand.

9. The image forming apparatus as claimed in claim 1, wherein the authentication part performs authentication by using billing information input by a user and available billing information registered beforehand.

10. The image forming apparatus as claimed in claim 1, the image forming apparatus further comprising hardware resources used for image forming processes, and control services that perform processes of the system side including control of the hardware resources,
wherein the image forming apparatus is configured so as to be able to install a plurality of applications separately from the control services, and the image forming apparatus includes the use control part as a control service.

11. The image forming apparatus as claimed in claim 1, the authentication part comprising:
a user information input part for a user to input user identification information and user authentication information;
an external server communication part for sending the user identification information input by the user to an external server, and receiving user authentication information corresponding to the user identification information from the external server; and
a part for determining whether the user authentication information received from the external server is the same as the user authentication information input by the user, and sending a determination result to the use control part.

12. The image forming apparatus as claimed in claim 1, the authentication part comprising:
a user information receiving part for receiving, from a client terminal, user identification information and first billing information indicating usage of the image forming apparatus by a user;
an external server communication part for sending the user identification information to an external server, and receiving second billing information corresponding to the user identification information from the external server;
a billing process part for comparing the first billing information received from the client terminal with the second billing information received from the external server, and sends a comparing result to the use control part.

13. The image forming apparatus as claimed in claim 12, wherein the client terminal reads the user identification information and the first billing information from an external recording medium, and the user information receiving part receives the user identification information and the first billing information from the client terminal.

14. The image forming apparatus as claimed in claim 11, wherein the external server is a LDAP server on a network.

15. A use control method for an application in an image forming apparatus in which a plurality of applications can be installed, the use control method comprising:
a use control step for receiving one or more authentication results from one or more authentication parts, and controlling use restriction for one or more applications according to the received one or more authentication results.

16. The use control method as claimed in claim 15, wherein the image forming apparatus refers to information indicating one or more authentication parts that correspond to an application, causes the one or more authentication parts to perform authentication process when the application is used, and sends an authentication result to the application.

17. The use control method as claimed in claim 15, wherein the image forming apparatus refers to information indicating one or more applications that correspond to an authentication part, and sends an authentication result of the authentication part to an application in the one or more applications when the application is used.

18. The use control method as claimed in claim 15, wherein the image forming apparatus controls use restriction for a function of an application.

19. The use control method as claimed in claim 15, wherein the image forming apparatus sends an authentication result indicating success of authentication to the one or more applications only when authentication by all of the one or more authentication parts succeeds.

20. The use control method as claimed in claim 15, wherein the image forming apparatus sends an authentication result indicating success of authentication to the one or more applications when authentication by at least one authentication part in the one or more authentication parts succeeds.

21. The use control method as claimed in claim 15, wherein each of the one or more authentication part is an application or an apparatus connected to the image forming apparatus.

22. The use control method as claimed in claim 15, wherein the authentication part performs authentication by using user authentication information input by a user and user authentication information registered beforehand.

23. The use control method as claimed in claim 15, wherein the authentication part performs authentication by using billing information input by a user and available billing information registered beforehand.

24. The use control method as claimed in claim 15, the image forming apparatus further comprising hardware resources used for image forming processes, and control services that perform processes of the system side including control of the hardware resources,
wherein the image forming apparatus is configured so as to be able to install a plurality of applications separately from the control services, and the use control step is performed by a control service.

25. The use control method as claimed in claim 15, the authentication part comprising:
a user information input part for a user to input user identification information and user authentication information;
an external server communication part for sending the user identification information input by the user to an external server, and receiving user authentication information corresponding to the user identification information from the external server; and
a part for determining whether the user authentication information received from the external server is the same as the user authentication information input by the user.

26. The use control method as claimed in claim 15, the authentication part comprising:
a user information receiving part for receiving, from a client terminal, user identification information and first billing information indicating usage of the image forming apparatus by a user;
an external server communication part for sending the user identification information to an external server, and receiving second billing information corresponding to the user identification information from the external server;
a billing process part for comparing the first billing information received from the client terminal with the second billing information received from the external server.

27. The use control method as claimed in claim 26, wherein the client terminal reads the user identification information and the first billing information from an external recording medium, and the user information receiving part receives the user identification information and the first billing information from the client terminal.

28. The use control method as claimed in claim 25, wherein the external server is a LDAP server on a network.

29. An image forming apparatus in which a plurality of applications can be installed, the image forming apparatus comprising:
a display part for displaying a screen, on an operation panel of the image forming apparatus, for selecting one or more applications for an authentication part, in which user authentication by the authentication part is applied to use of the one or more applications; and
a use control part for receiving an authentication result from the authentication part, and controlling use restriction for the one or more applications according to the authentication result.

30. The image forming apparatus as claimed in claim 29, wherein information input from the screen is stored in the image forming apparatus as information indicating the one or more applications corresponding to the authentication part.

31. The image forming apparatus as claimed in claim 29, wherein the display part displays a screen for selecting one or more functions of an application to which user authentication by the authentication part is applied.

32. An image forming apparatus in which a plurality of applications can be installed, the image forming apparatus comprising:
a display part for displaying a screen, on an operation panel of the image forming apparatus, for selecting one or more authentication parts for an application, in which user authentication by the one or more authentication parts can be applied to use of the application; and
a use control part for receiving one or more authentication results from the one or more authentication parts, and controlling use restriction for the application according to the one or more authentication results.

33. The image forming apparatus as claimed in claim 32, wherein information input from the screen is stored in the image forming apparatus as information indicating the one or more authentication parts corresponding to the application.

34. The image forming apparatus as claimed in claim 32, wherein the display part displays a screen for setting relationship among the one or more authentication parts.

35. The image forming apparatus as claimed in claim 32, wherein the display part displays a screen for setting information indicating that user authentication for use of the application succeeds only if authentication by all of the one or more authentication parts succeeds.

36. The image forming apparatus as claimed in claim 32, wherein the display part displays a screen for setting information indicating that user authentication for use of the application succeeds if authentication by at least one of the one or more authentication parts succeeds.

37. The image forming apparatus as claimed in claim 29, wherein the authentication part performs authentication by using user authentication information input by a user and user authentication information registered beforehand.

38. The image forming apparatus as claimed in claim 29, wherein the authentication part performs authentication by using billing information input by a user and available billing information registered beforehand.

39. The image forming apparatus as claimed in claim 29, the image forming apparatus further comprising hardware resources used for image forming processes, and control services that perform processes of the system side including control of the hardware resources,
wherein the image forming apparatus is configured so as to be able to install a plurality of applications separately from the control services, and the image forming apparatus includes the use control part and the display part as a control service.

40. A use control method for an application in an image forming apparatus in which a plurality of applications can be installed, the use control method comprising:
a display step for displaying a screen, on an operation panel of the image forming apparatus, for selecting one or more applications for an authentication part, in which user authentication by the authentication part is applied to use of the one or more applications; and
a use control step for receiving an authentication result from the authentication part, and controlling use restriction for the one or more applications according to the authentication result.

41. The use control method as claimed in claim 40, wherein information input from the screen is stored in the image forming apparatus as information indicating the one or more applications corresponding to the authentication part.

42. The use control method as claimed in claim 40, wherein the image forming apparatus displays a screen for selecting one or more functions of an application to which user authentication by the authentication part is applied.

43. A use control method for an application in an image forming apparatus in which a plurality of applications can be installed, the use control method comprising:
a display step for displaying a screen, on an operation panel of the image forming apparatus, for selecting one or more authentication parts for an application, in which user authentication by the one or more authentication parts can be applied to use of the application; and
a use control step for receiving one or more authentication results from the one or more authentication parts, and controlling use restriction for the application according to the one or more authentication results.

44. The use control method as claimed in claim 43, wherein information input from the screen is stored in the image forming apparatus as information indicating the one or more authentication parts corresponding to the application.

45. The use control method as claimed in claim 43, wherein the image forming apparatus displays a screen for setting relationship among the one or more authentication parts.

46. The use control method as claimed in claim 43, wherein the image forming apparatus displays a screen for setting information indicating that user authentication for use of the application succeeds only if authentication by all of the one or more authentication parts succeeds.

47. The use control method as claimed in claim 43, wherein the image forming apparatus displays a screen for setting information indicating that user authentication for use of the application succeeds if authentication by at least one of the one or more authentication parts succeeds.

48. The use control method as claimed in claim 40, wherein the authentication part performs authentication by using user authentication information input by a user and user authentication information registered beforehand.

49. The use control method as claimed in claim 40, wherein the authentication part performs authentication by using billing information input by a user and available billing information registered beforehand.

50. The use control method as claimed in claim 40, the image forming apparatus further comprising hardware resources used for image forming processes, and control services that perform processes of the system side including control of the hardware resources,
wherein the image forming apparatus is configured so as to be able to install a plurality of applications separately from the control services, and the display step and the use control step are performed by a control service.
